(19) United States
(12) Patent Application Publication
(10) Pub. No.: US 2006/0083802 A1
(43) Pub. Date: Apr. 20, 2006

(54) Mold for molding the shape of the cane of a growing bamboo

(76) Inventor: Wen-Tsan Wang, Taipei (TW)

Correspondence Address: LEONG C LEI, PMB # 1008, 1867 YGNACIO VALLEY ROAD, WALNUT CREEK, CA, 94598, US

(21) Appl. No.: 10/968,122

(22) Filed: Oct. 20, 2004

(51) Int. Cl. A01F 25/00

(52) U.S. Cl. 425/2

(57) ABSTRACT

A mold formed of a first mold plate and a second mold plate for wrapping about the cane of a growing bamboo between two nodes to limit the growing direction of the cane of the growing bamboo and to control the shape of the contour of the cane of the growing bamboo.

### BACKGROUND OF THE INVENTION

1. Field of the Invention

The present invention relates the raising of bamboos and more particularly, to a mold for molding the shape of the cane of a growing bamboo.

2. Description of the Related Art

A variety of materials such as glass, wood, bamboo, plastics, stainless steel, and etc. may be used for making storage containers and cabinets. In order to attract consumers to buy, the shape design of a storage container is important. For the advantages of natural and classic features, wood and bamboo materials are greatly appreciated by consumers. Manufacturers may use bamboo strips to make baskets and storage containers that have a meshed structure. However, human works lower the sense of nature. Further, the canes of bamboos have only the cylindrical shape. Manufacturers can make a great change on the shape of the cross section of the cane of a bamboo without destructing the natural beauty of the cane.

### SUMMARY OF THE INVENTION

The present invention has been accomplished under the circumstances in view. It is the main object of the present invention to provide a mold for molding the shape of the cane of a growing bamboo, which limits the growing direction of the cane of the growing bamboo, controlling the shape of the contour of the cane. According to one aspect of the present invention, the mold is comprised of a first mold plate and a second mold plate. The first mold plate and the second mold plate can be fastened together and wrapped about the cane of a growing bamboo to control the shape of the contour of the cane of the growing bamboo. The first mold plate and the second mold plate can be so designed that the mold defines a cavity having a triangular, heart-shaped, or rectangular cross section for receiving the cane of a growing bamboo. According to one embodiment of the present invention, the first mold plate and the second mold plate are fastened together with screw bolts and nuts. According to another embodiment of the present invention, the first mold plate and the second mold plate are fastened together by means of a hook joint.

### BRIEF DESCRIPTION OF THE DRAWINGS

FIG. 1 is a schematic drawing showing an application example of the present invention.

FIG. 2 is an exploded view of a mold constructed according to one embodiment of the present invention.

FIG. 3 is an exploded view of an alternate form of the mold according to the present invention.

FIG. 4 is a cross-sectional view showing the mold of FIG. 2 fastened to the cane of a growing bamboo.

FIG. 5 is a cross-sectional view showing the mold of FIG. 3 fastened to the cane of a growing bamboo.

FIG. 6 illustrates one segment of a heart-shaped bamboo cane obtained according to the present invention.

FIG. 7 illustrates one segment of a triangular bamboo cane obtained according to the present invention.

FIG. 8 is an exploded view of another alternate form of the mold according to the present invention.

FIG. 9 is an exploded view of still another alternate form of the mold according to the present invention.

FIG. 10 is a cross-sectional view showing the mold of FIG. 8 fastened to the cane of a growing bamboo.

FIG. 11 is a cross-sectional view showing the mold of FIG. 9 fastened to the cane of a growing bamboo.

FIG. 12 is a perspective view of still another alternate form of the mold according to the present invention.

### DETAILED DESCRIPTION OF THE INVENTION

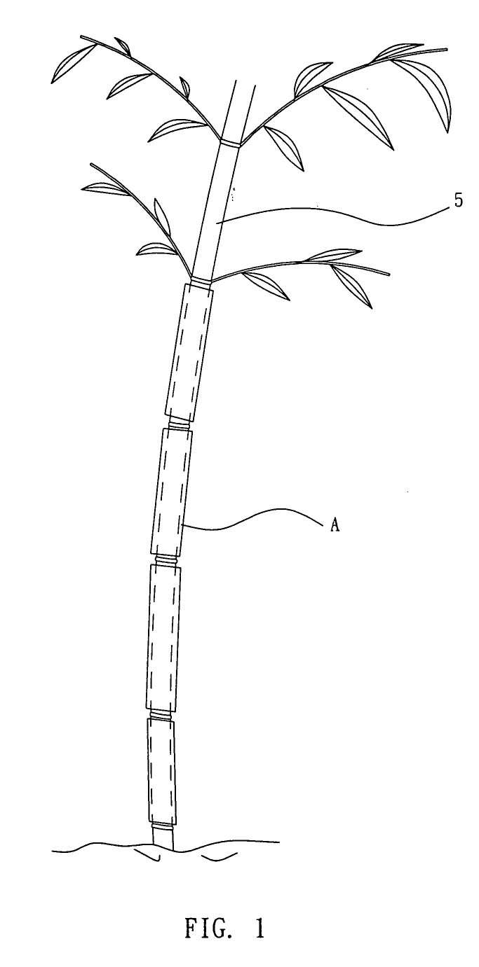

Referring to FIG. 1, a mold A is wrapped about the cane of a growing bamboo 5 between two nodes of the cane. Preferably, the mold A is fastened to the cane of the growing bamboo 5 above between the third and fourth nodes above the ground. The mold A limits the growing direction of the cane of the growing bamboo 5, controlling the shape of the contour of the cane of the growing bamboo 5.

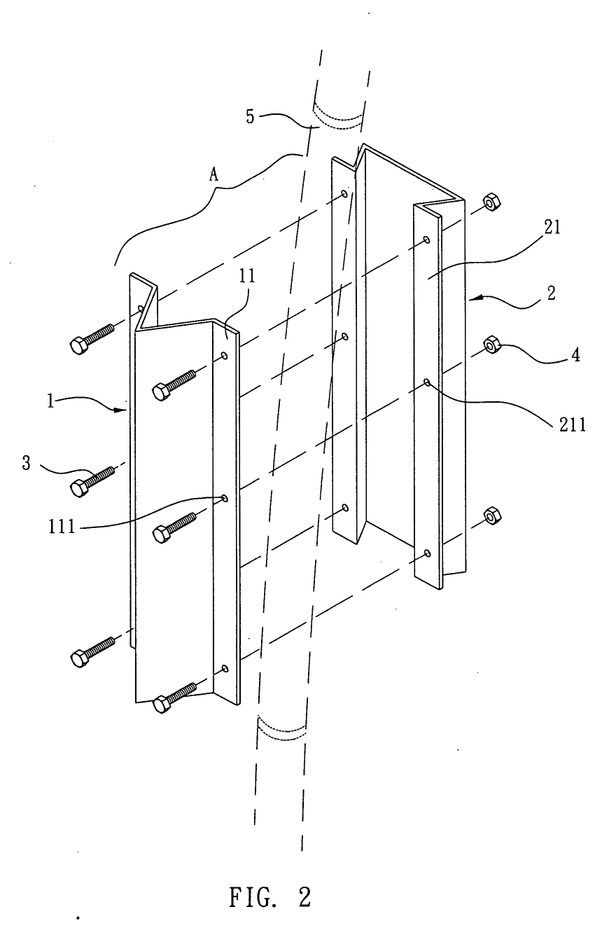

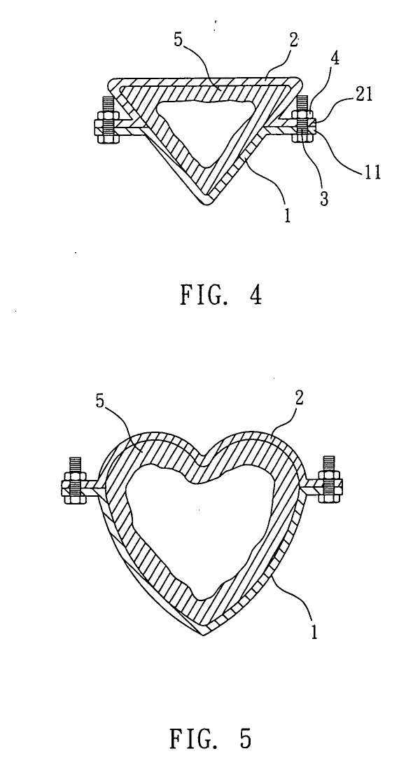

Referring to FIGS. 2, 4, the mold A is comprised of a first mold plate 1 and a second mold plate 2. The first mold plate 1 has two mounting flanges 11 longitudinally arranged in parallel at two opposite lateral sides, and a plurality of mounting through holes 111 formed in the mounting flanges 11. The second mold plate 2 has two mounting flanges 21 longitudinally arranged in parallel at two opposite lateral sides, and a plurality of mounting through holes 211 formed in the mounting flanges 21. Screws 3 are respectively inserted through the mounting through holes 111 of the first mold plate 1 and the mounting through holes 211 of the second mold plate 2 and fastened up with respective nuts 4 to fasten the first mold plate 1 and the second mold plate 2 together and to secure the first mold plate 1 and the second mold plate 2 to the periphery of the cane of the growing bamboo 5. Further, the first mold plate 1 and the second mold plate 2 are so designed that the mold A defines a triangular cavity for constraining the cane of the growing bamboo 5 to grown subject to the confined cross section of triangular pattern. After the bamboo 5 has been growing to a certain extent of maturity, the cane of the bamboo 5 shows a triangular cross section (see FIG. 7).

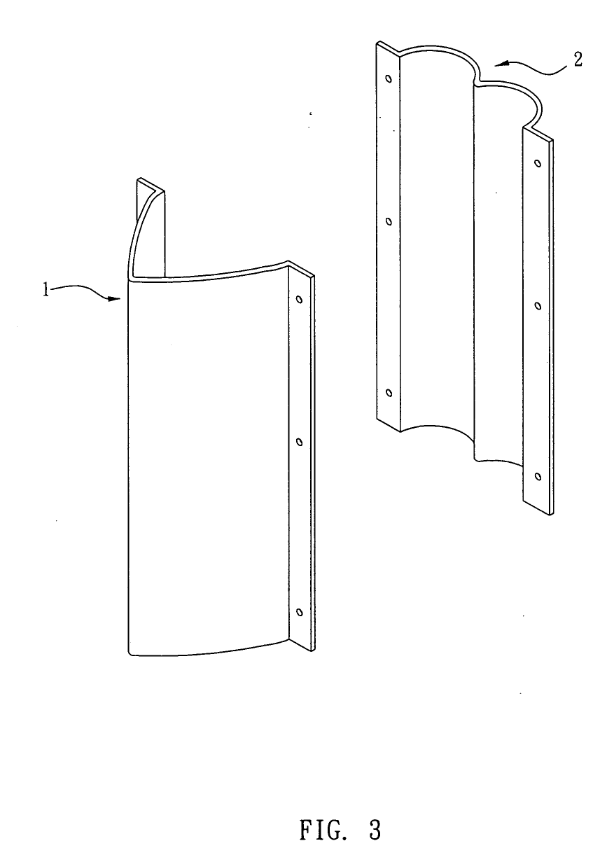

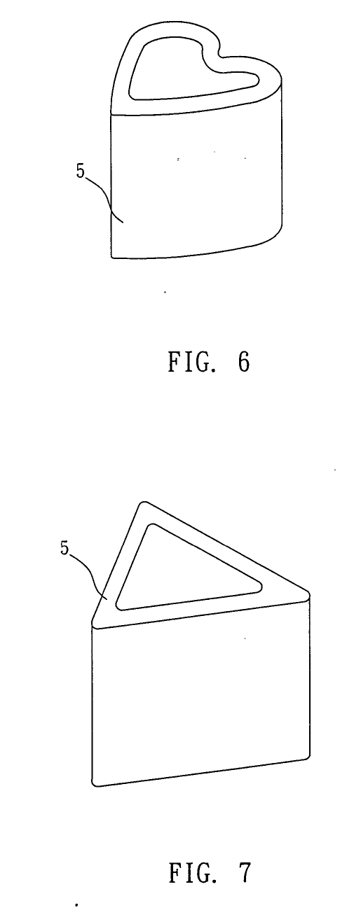

FIGS. 3, 5 and 6 show an alternate form of the present invention. According to this embodiment, the first mold plate. 1 and the second mold plate 2 are so designed that the mold A defines a cavity of heart-shaped cross section for constraining the cane of the growing bamboo 5 to grown subject to confined cross section of heart-shaped pattern.

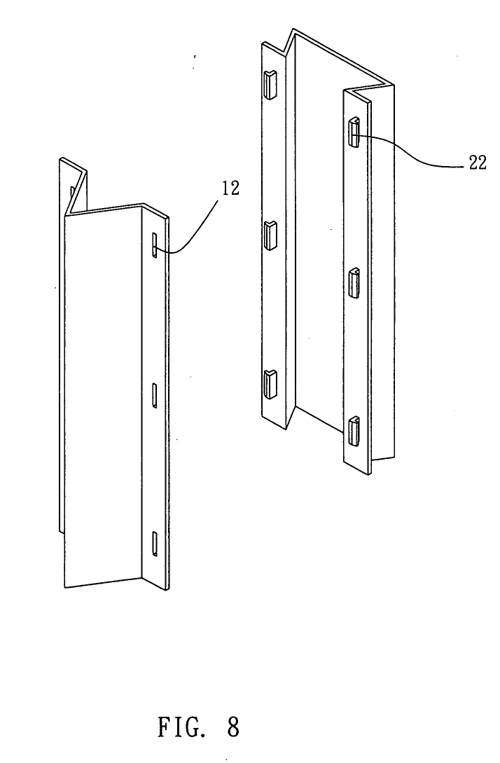

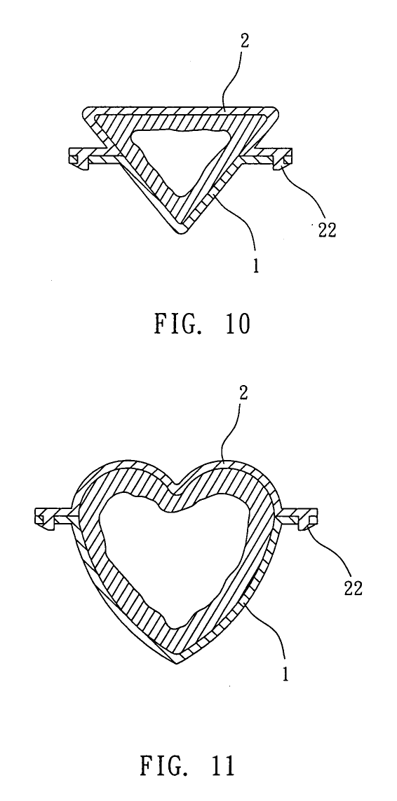

FIGS. 8 and 10 show another alternate form of the present invention. According to this embodiment, the first mold plate 1 has hook holes 12 symmetrically arranged at two opposite lateral sides at different elevations, and the second mold plate 2 has hooks 22 symmetrically arranged at two opposite lateral sides at different elevations for hooking in the hook holes 12 to secure the second mold plate 2 to the first mold plate 1. According to this embodiment, the first mold plate 1 and the second mold plate 2 defines a cavity of triangular cross section.

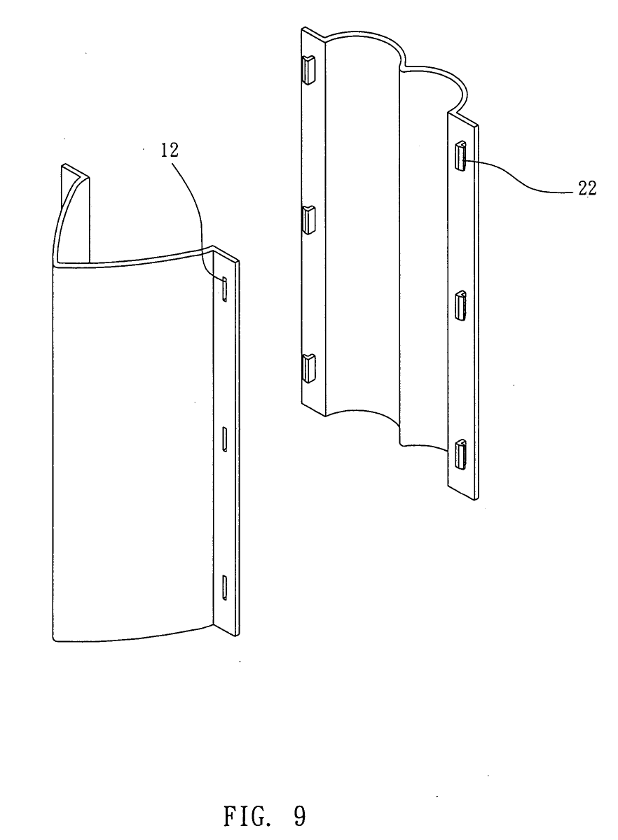

FIGS. 9 and 11 show still another alternate form of the present invention. This embodiment is substantially similar to the embodiment shown in FIGS. 8 and 10 with the exception that the cavity defined in between the first mold plate and the second mold plate has a heart-shaped cross section.

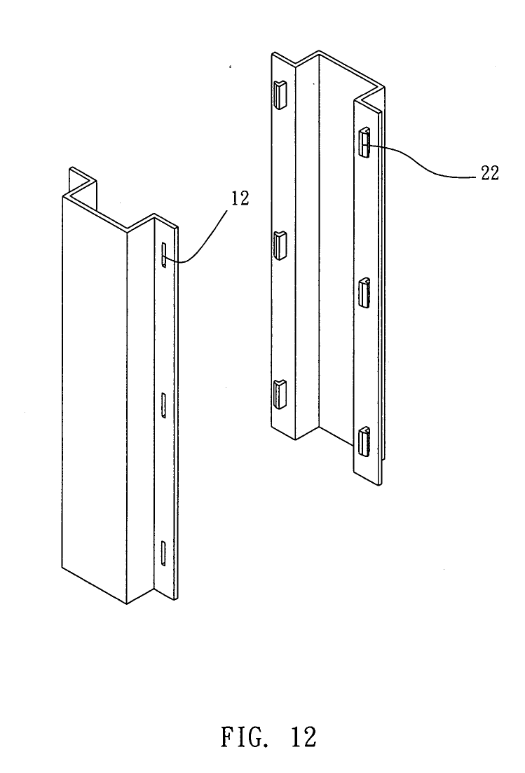

FIG. 12 shows still another alternate form of the present invention. According to this embodiment, the mold defines a cavity of rectangular cross section.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A mold for wrapping about the cane of a growing bamboo between two nodes of the cane of the growing bamboo to limit the growing direction of the cane of the growing bamboo and to control the shape of the contour of the cane of the growing bamboo, the mold comprising a first mold plate, a second mold plate connectable to said first mold plate to define with said first mold plate a cavity for molding the shape of the cane of a growing bamboo, and fastening means to fasten said first mold plate and said second mold plate together and to secure said first mold plate and said second mold to the cane of a growing bamboo.

2. The mold as claimed in claim 1, wherein said first mold plate and said second mold plate each have two mounting flanges symmetrically disposed at two opposite lateral sides and a plurality of mounting through holes respectively formed in said mounting flanges at different elevations; said fastening means comprises a plurality of screw bolts respectively mounted in the mounting through holes of said first mold plate and the mounting through holes of said second mold plate, and a plurality of nuts respectively threaded onto said screw bolts to secure said first mold plate and said second mold plate together.

3. The mold as claimed in claim 2, wherein said first mold plate and said second mold plate each have two mounting flanges symmetrically disposed at two opposite lateral sides; said fastening means comprises a plurality of hook holes respectively formed in the mounting flanges of one of said first mold plate and said second mold plate at different elevations, and a plurality of hooks respectively provided at the mounting flanges of the other of said first mold plate and said second mold plate for hooking in said hook holes.

4. The mold as claimed in claim 1, wherein said first mold plate and said second mold plate define a mold cavity having a triangular cross section.

5. The mold as claimed in claim 1, wherein said first mold plate and said second mold plate define a mold cavity having a heat-shaped cross section.

6. The mold as claimed in claim 1, wherein said first mold plate and said second mold plate define a mold cavity having a rectangular cross section.
